(19) United States
(12) Patent Application Publication
(10) Pub. No.: US 2011/0079655 A1
(43) Pub. Date: Apr. 7, 2011

(54) METHOD OF MANUFACTURING DYNAMIC VIRTUAL SIPHONS

(76) Inventor: John McNulty, Daklkey (IE)

(21) Appl. No.: 12/736,843

(22) PCT Filed: May 5, 2009
(86) PCT No.: PCT/GB2009/001113

§ 371 Date: Nov. 5, 2010

(30) Foreign Application Priority Data
May 6, 2008 (GB) 0808170.5

(51) Int. Cl. A01G 15/00

(52) U.S. Cl. 239/2.1; 239/14.1

(57) ABSTRACT

A method for producing elongated, rotating, dynamically controllable, cyclostrophically balanced, fluid virtual siphon columns, wherein: the term fluids covers any media capable of flow, including particulates; the fluid/s can be a single medium or a mixture of materials capable of flow; the fluid/s entrain such flow in themselves and/or other fluid/s preferably by means of initialising near axially-fed outwardly spinning, centrifugal, upward motion with coherent convection, thus creating largely self-sustaining, rising updraft, rotational, cyclostrophically balanced fluid virtual siphon columns of considerable length. Such columns can be made visible by means of condensed water, bubbles, smoke or particulate matter and may be illuminated for greater visual effect. Other uses for employing such controllable upwardly flowing fluid columns are explored.

### TECHNICAL FIELD

This invention teaches a radical approach to creating and maintaining dynamic, fluid ‘virtual siphons’ comprising any fluids (gas, liquid or fluidised suspensions) with alternative solutions to some commonly encountered problems in the fields mentioned below. In this invention I take advantage of some of the unique characteristics possessed by ‘virtual siphons’ and therefore take care to describe the background to the physical approaches employed in the exemplary embodiments described later.

Keywords: Siphon, Syphon, Fluid, Plume, Vortex, Cloud Fountain, Cyclostrophic Balance, Water Spout, Column, Virtual Chimney, Funnel, Coherent Convection.

### BACKGROUND AND PRIOR ART

The Ancient Greek, Ctesibius, followed by Hero (a.k.a. Heron) of Alexandria, produced numerous siphonic innovations, one later employed in ‘Hero's Fountain’. Hero's eponymous device allows us to explore the physical principles later embodied by Pascal (who assisted with the fountains at Versailles) and Bernoulli. In general terms, raising a fluid mass any distance involves well-known mechanical/kinetic (Joulean) limitations. In view of continuing common widespread misconceptions about siphons, it is worth reiterating that any siphon owes its operation to gravity and not to atmospheric pressure (which itself derives from gravity—thus, a suitably low vapour pressure fluid, like mercury, would siphon satisfactorily on the Moon). Additional to the pressure applied—whether by ‘head’ (i.e. superior fluid mass) or by mechanical impulsion of any sort—considerations of frictional losses, turbulence and material resilience must also limit the height which any conventional siphon can attain. However, throughout our planet's surface Nature recurrently powers the hydrodynamic cycle, during which oceanic quantities of water are raised for many miles and then lowered. Although popular usage refers to warm air (implicitly and/or water vapour) ‘rising’—we do know, courtesy of Archimedes and Galileo, that gravitational action on denser material ‘displaces’ the less dense material (usually attenuated by heat from solar or other sources) and forces it buoyantly upwards. It is, therefore, the gravitational, and consequently atmospheric, pressing down that causes any perceived upward motion. Frictional losses and the resistance from layers or strata above the warmer air usually impede convection. Resultantly the bubbles of warm air tend to wander chaotically and often slide sideways, creating winds. Most notably Louis Michaud, in his pivotal papers and patents, teaches how natural convection can sometimes organise itself into ‘twisters’, dust devils, waterspouts and the like. Michaud proposed an Atmospheric Vortex Engine that synthetically encourages such a process. Michaud suggests certain substantial physically fixed-size embodiments and primarily sees such producing employable energy or meteorological effects. Michaud realised that, given a suitable conduit, less dense air rises vertically for great distances with very little impedance. Subsequently, more air rushes in at the base to replace the escaped air, providing mechanical work. Whilst Michaud aims to capture mechanical work primarily to drive turbines, within this patent I propose to employ such work to transport fluids but do not exclude other useful employments. Additionally and crucially, although Michaud's fixed-size solid material embodiments may be admirably suited for his purposes, I propose entirely different means of manufacture with flexibly sized dynamic embodiments thereof to attain mine.

### BRIEF DESCRIPTION OF DRAWINGS

To better aid understanding of what may be hard-to-visualise ‘virtual processes’ I supply the following illustrations:

FIG. 1 is a simplified systems flow block diagram in ascending flow sequence

FIG. 2 shows a hyperbolic funnel as an idealised flow geometry diagram

FIG. 3 extends FIG. 2 and shows the systems flow components in an idealised manner

FIG. 4 develops FIGS. 2 & 3 with more systems flow components

FIG. 5 shows an alternative arrangement of the systems flow components

FIG. 6 explains the typical operation of a Trombe or Trompe Pump

FIG. 7 portrays the virtual base/container and the resultant virtual siphon column

FIG. 8 repeats FIG. 7 but also shows the means for harnessing power

FIG. 9 extends and explains by photo and sketch the fluid dimple shown in FIGS. 7 & 8

### DISCLOSURE OF INVENTION

### Focus of Invention

Looking again to Nature, we see that impressive columns of water, mist, sand and the like regularly whirl far up into the atmosphere; normally such phenomena are highly ephemeral. Synthesising such siphons in a continuously controllable manner could, inter alis provide: power; impressive displays in themselves; projection ‘screens’ for illuminated effects; as well as other useful employments enumerated further below. This invention's vital focus is the physical attainment of dynamically adjustable, controllable virtual siphons of unparalleled volume and height, more than the specific means or media employed, although many other beneficial applications may also accrue.

### Simple Analogies to Aid Understanding

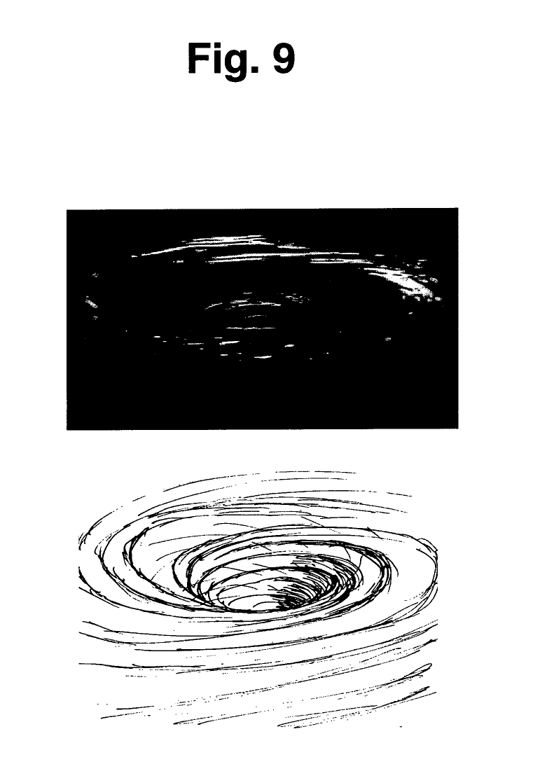

Perhaps two commonplace analogies may aid understanding later. If we were to direct a powerful water hose's stream into a bowl, causing the body of water to rotate; we may also see entrained bubbles of air arising somewhat to the centre of our recently created circulation. Also, in the kitchen, if we filled a glass cooking vessel with water and applied heat below, whilst smoothly stirring in one direction we would see bubbles rising around the central axis and a slight dimpling [shown greater in FIG. 9] central to the water's surface. With minimal air currents and suitable lighting, we might also see a white plume column ascending axially from the water, instead of the usual random cloudy billows.

### The Current Invention

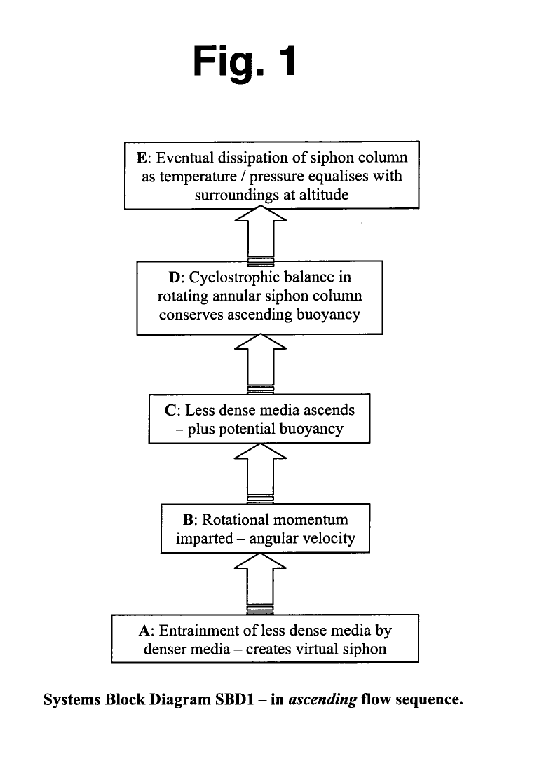

Accordingly, I propose novel, radical approaches to creating and maintaining dynamically adjustable, controllable virtual siphon columns that will overcome or minimise many of the problems encountered in current offerings and proposals. Where the terms ‘fountain’ or ‘column’ are used, this refers to all fluid forms of siphons and can in principle be extended to any other fluid form including vapour, smoke, steam, solids, dust, bubbles and the like. I use the term ‘virtual’ to indicate that dynamic fluid media can replace the conventional permanently fixed conduit materials (tubing and the like) used to contain and construct siphons. In these specific, preferred embodiments I take a vortical mist or cloud column/fountain as an exemplar. Some particular advantages—of such a columnar siphon operating within a ‘virtual’ conduit—emerge: that the typical material, construction and energy demands are reduced dramatically and water consumption is minimised; further advantages include local cooling/air-conditioning, cleaning local air, purifying water to supply potable and irrigation water and even achieving a positive energy balance that generates power. In preferred and exemplary embodiments of this invention I also refer to a notional systems block diagram SBD1 [FIG. 1] that enumerates and describes the main ascending system flow components. These steps are: A Entrain less dense fluid media by denser fluid media; B Impart cyclostrophic rotation; C Buoyant ascent of less dense media; D Imparted cyclostrophic balance maintains siphon system throughout ascending buoyancy; E Virtual siphon column eventually dissipates.

For the sake of clarity I outline typical virtual siphons contained within a small, local geographic curtilage although the principles outlined herein are equally applicable on any scale. Here I assume for these examples that the exemplary virtual siphon system uses water and air, although any other means or media could also benefit from this invention.

### Systematic Description

Because the very notion of a virtual siphon may seem counter-intuitive, even though such structures abound in Nature and are described in public domain literature, I first take a simplified physical structure as a model to demonstrate the system process flow. As Count Rumford, Michaud et at taught, a physical chimney acts as a conduit, separating a column of more buoyant air (smoke or steam) and guiding it upwards with less atmospheric interference, friction and dissipation. Imparting spin to such a buoyant column enhances its behaviour, particularly at the exit. If the physical chimney were removed—assuming the rising, spinning column is sufficiently robust (wide and energetic)—it would maintain itself in cyclostrophic balance, acting as a ‘virtual chimney’ with the eye-wall as a ‘force field’. In strict Count Rumford-style classification, a chimney is a sub-set of the thermo-siphon, which is a class of siphon. Such public domain teaching is well known to those versed in the art, although some specific variants appear in patents.

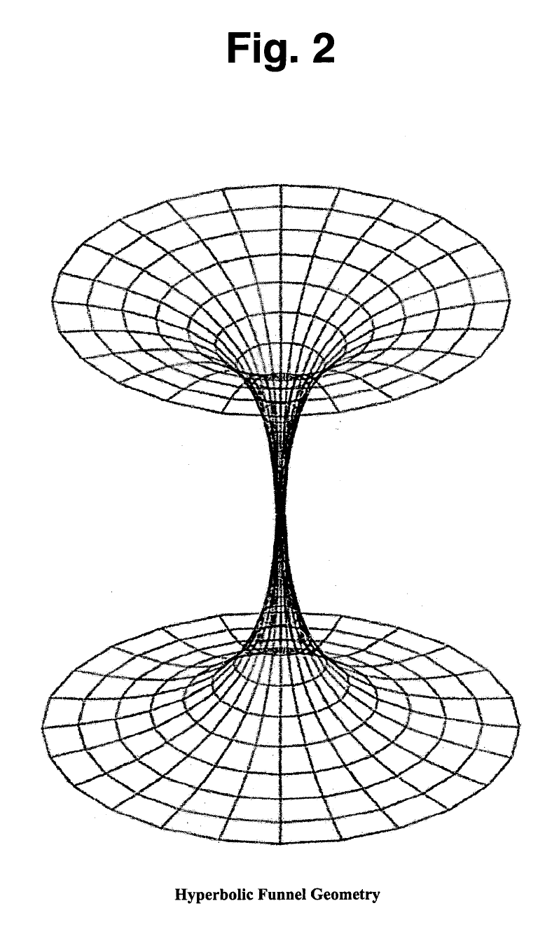

Examining natural vortical phenomena's inherent idealised geometry, one can determine that the visible funnel (‘trombe’ or trumpet) conforms to a broadly hyperbolic theme [FIG. 2]. More properly, the flow lines (not always visibly manifested) comprise some hyperbolic cone variants (depending on local conditions) and may be considered as shaped akin to an hourglass, a diabolo (a double funnel) or a traditional bed-mattress spring—neglecting the specific dimensional extent of the various components, particularly the ‘waist’ or ‘neck’ which may rise vertically for kilometres. (NB the spin may be clockwise or anticlockwise, depending on the impulsion means and orientation).

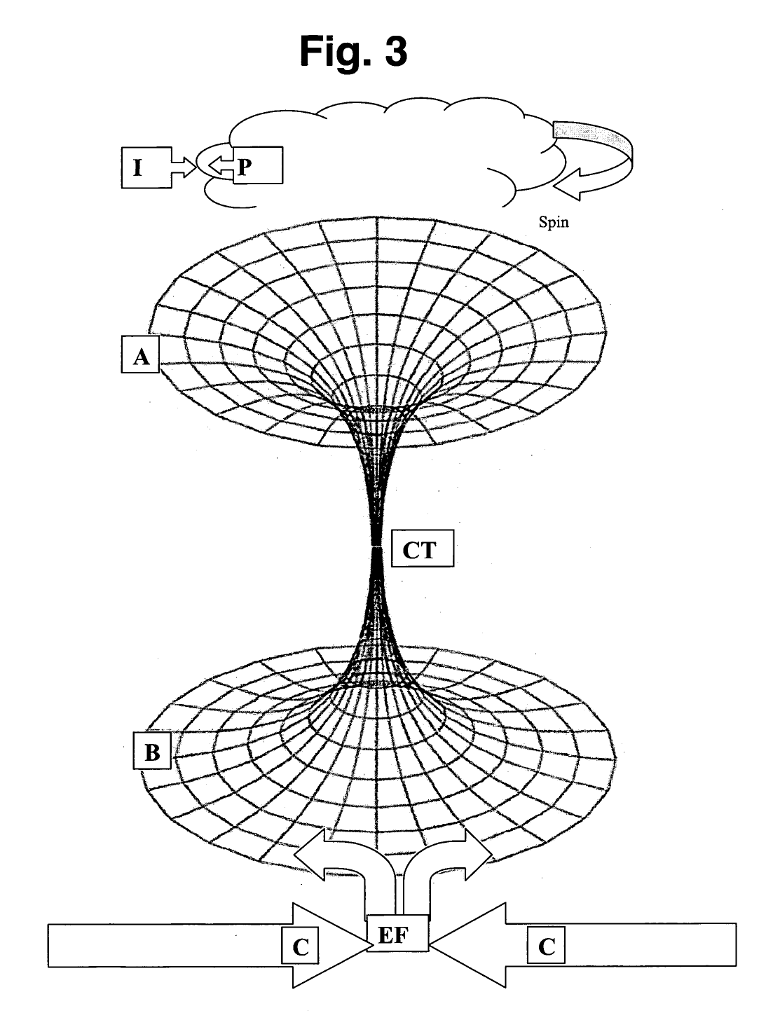

Returning to a specific, physical model [FIG. 3], somewhat echoing natural siphons, I propose to encourage synthetic virtual siphon formation by means of two funnels [A&B], (or CT a multiplicity thereof), preferably of the hyperbolic form, conjoined by a connecting tube [CT], which may be a simple tubular neck connection of any length or may be curved or sinusoidal.

Mainly for illustrative purposes, in the simplest exemplar: two funnels [A&B], conjoined at a narrower neck, diabolo style, sit with one of the wider mouths as a base and their hollow axes vertical. Entraining fluid/s [EF] (e.g.; warm moist air, water sprays, smoke, mixtures or other suitable media) enter/s axially via conduits [C] within the base axis, then cling/s to the interior wall preferentially (courtesy Coanda, Venturi, Bernoulli) whilst minimising turbulent/frictional losses and rise/s in an involuting spiral. As the lower, inverted, funnel narrows at its apex, angular momentum conservation causes an increasing centrifugal spin in the ascending spiral and the central vertical axis experiences lower pressure. Maximum spin occurs at the connecting neck and then spirals outwards and upwards within the upper funnel. As the spiralling, coaxial column ascends further, two forces—the ‘imaginary’ centrifugal outward force [I] and the in-pressing atmospheric pressure [P]—balance themselves dynamically in cyclostrophic opposition until such elapsed time and altitude as the various energies dissipate. The major energetic ingredients are the heat and pressure/density differentials, coupled with the imparted rotational torque—all of which are influenced by the geometrical dimensions, particularly the base, entry and exit diameters.

I now turn to the questions of powering such systems. Every rational person must always take great care to obey the Laws of Thermodynamics, that is, to avoid any chimerical pursuit of a non-existent ‘free lunch’. It is therefore important to examine the sources and application of power. In the foregoing and following, I refer to various means for providing the spin and the buoyant ‘lift’—regardless of the specific fluid medium (moist air, water, smoke, dust and so on). A convenient and readily available means of producing driving jets is by electric turbines. Another impulsive means would be via rapid expansion (e.g. steam jets or flames) whether pulsed or continuous. Another means would be natural convection encouraged via spin enhancing geometries and heat and pressure/density differences. Whatever impulsive means are chosen, as with a conventional siphon, there will be an initial ‘starting’ demand to provide momentum.

Once a rotating siphon column is established, its maintenance will require less power. Depending on the pressure/density and temperature gradients between the base and the ‘top’ of the siphon column, considerable upward flow (updraft) will ensue. Some of this up-spinning flow may be harnessed to carry an extra workload and/or some display medium (water, steam, smoke, dust and so on). This additional load may be continuous or modulated for various effects. If the ingress of the working media/fluids is arrested or inhibited, or the spin stopped or reversed in direction, then the column will dissipate.

However, it should be clear that, if an efficient conduit exists, then the potential differences of pressure and temperature between base and top make for a mighty ‘Carnot Engine’. It is therefore entirely reasonable to assume that some of the useful workload could be employed for powering the lighting and maintenance of the siphon. In fact there could be a remarkable excess of available power once the siphon column was established. One way to harness such a flow would be via the turbines and conduits initially used to start the siphon. Ever since Zenobius Gramme's fortuitous discovery we know that an electric dynamo can also be a motor and vice versa. We can therefore envisage the same impulsive means being employed later in the process either for braking or generating.

At this point the wisely alert reader may question the fountainhead of such power.

The ultimate source is the same that Sadi Carnot noted as motivating the weather system—that which also powers our hydroelectric schemes—gravitational attraction, acting in concert with the sun and our atmosphere. We tend to overlook gravity's invisible handiwork in powering convection and yet, sine qua non, wanting gravity we would have no convection. Half the convective cycle (the falling return) comes ‘gratis’ courtesy the gravitational discoveries of Galileo et al, whilst the other arises—via the gravitational Archimedean displacement process—from the Sun (or other thermal sources, or from attenuation). As Michaud taught, whether we harness such forces or not, they exist in vast recirculating quantities; he noted that a raindrop still falls if we channel its potential via a hydroelectric dam or waste it in a spendthrift splash. The natural power cycle continues, indifferent to its utilisation.

Having described in simplified form the essential principles involved, I now make a number of radically inventive steps.

### Exemplary Embodiment Mainly for Illustration of the Process

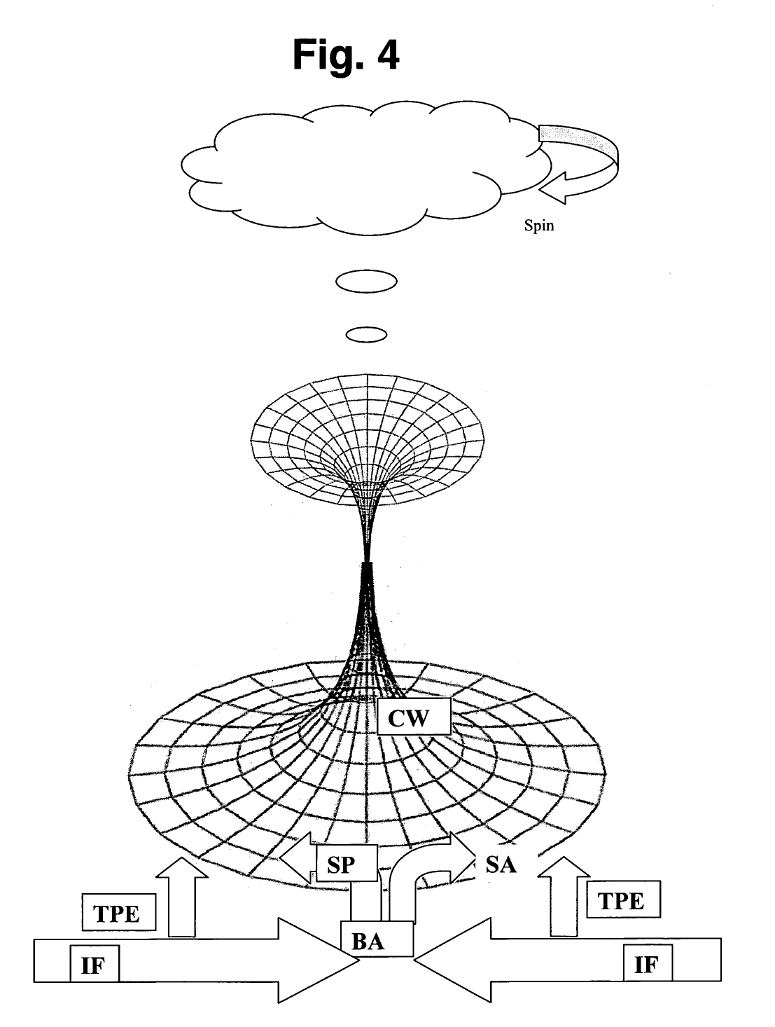

The first idealised embodiment [FIG. 4] could adopt the hourglass/diabolo funnel form as described above. The specific geometrical dimensions and proportions would be adapted to particular local circumstances.

For example the upper funnel cone could exhibit a much shorter vertical (and other) dimensions than the base cone. Well-known means of boundary surface friction reduction, such as ‘fluidised bed’, or ‘skin effect’ techniques or others could be borrowed from the fluid and aerodynamic sciences and applied to the inner cone surfaces, as could ‘rifling tracks’ to encourage spin. Additionally, air and/or water entering at, or near, the base axis [BA] could be complemented by tangential near perimeter entries [TPE].

Further, in the central base axial entry, shaped conduits [SC] could lead the incoming fluid(s) [IF] to jet out either from static ports [SP] or via dynamically spinning arms [SA] (somewhat reminiscent of a Hero's Engine or a circularly rotating lawn sprinkler) so that the fluid/s preferentially hug the cone-wall [CW], thus ascending spiral pathways.

The choice whether to impel the incoming driving, entraining fluid streams by extra energetic means, or to rely on existing forces (gravitational pressure/density differences, local heat differences) will depend on the particular application and ambient conditions.

### BEST MODES FOR CARRYING OUT THE INVENTION—AND INDUSTRIAL APPLICABILITY

### Embodiments with Radically Inventive Progressive Steps

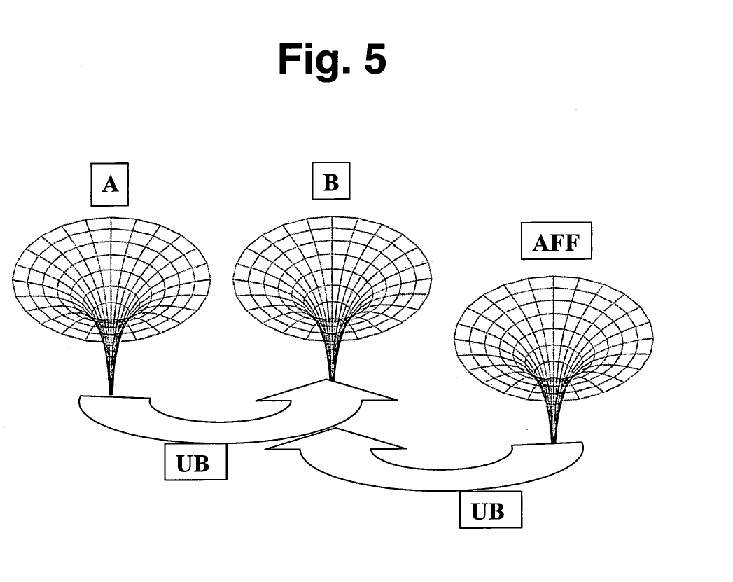

A second idealised embodiment [FIG. 5] could employ the methods described above but with several radically inventive departures. By taking the neck or waist section of the hourglass/diabolo configuration and extending it into a U-bend [UB], we can envisage two funnels [A & B] in their more customary attitude (wide diameter upwards) and joined by an elongated, curved narrower conduit.

Effectively, this approach employs gravity more conventionally by explicitly using the normal downward gravitational acceleration in the ‘feed’ funnel in addition to whatever other impulsive spin means are employed. Clearly, additional ‘feed’ funnels [AFF] may be conjoined multiply to increase the effective input and spin to the final ‘neck’ and output. Various well-known piping techniques may advantageously be employed here (in addition to Venturi, eductor and other entrainment methods) so that other fluid media may be drawn in and mixed with the stream/s; thus enhancing the energetic, pressive or visible effectiveness.

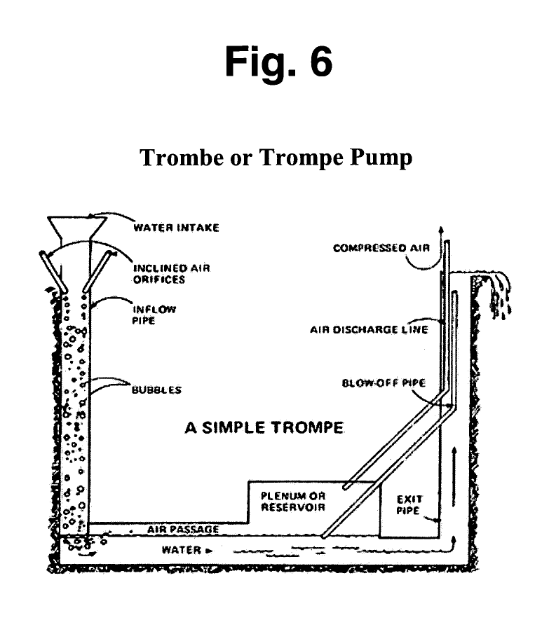

In this entrainment arrangement, the similarities to the ‘Trompe Pump’ entrainment approach may be clearer [FIG. 6], although entrainment applies to all the embodiments herein.

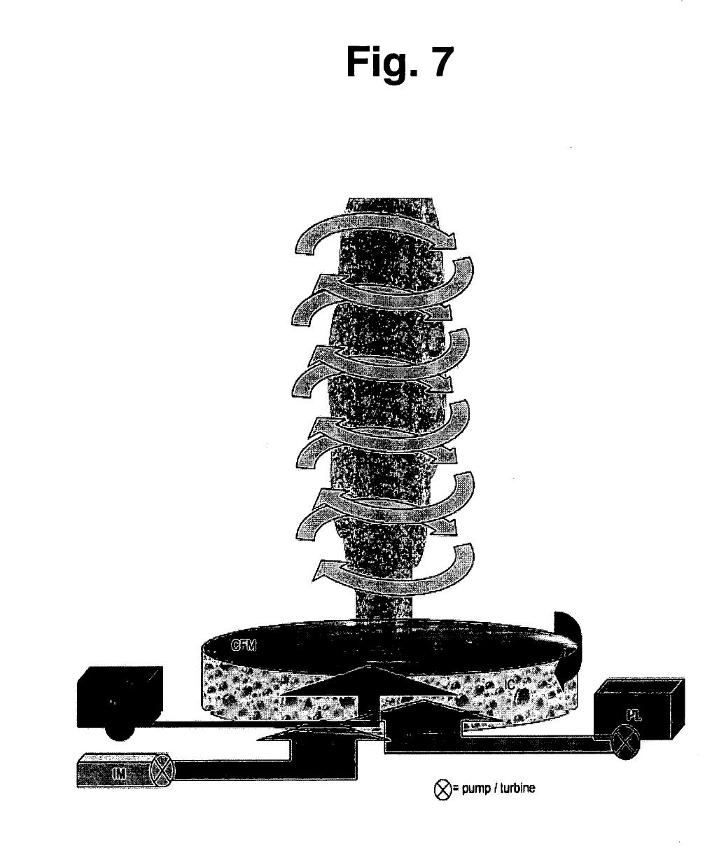

A third idealised embodiment [FIG. 7] could be built along the principles so far outlined, but with a novel, completely different approach to manufacture.

Taking particularly the second embodiment outlined above, it is possible to make the funnel cones from almost any material—even temporary or dynamic ones. In the latter case, a suitable medium could be spun into an acceptable conformal shape and then ‘fixed’ and continuously maintained in a dynamic, spun or pumped manner to create virtual fluid funnels and conduits. In the dynamic ‘virtual’ case, very little material would be needed for construction other than suitable ‘plumbing’, impulsion means and a conformal fluid medium.

As a specific example, water could be spun and then effectively set/frozen into a suitable configuration—regardless of its particular phase (e.g. consider, metaphorically, an ice funnel). As I am invoking a hard-to-visualise second virtual structure to drive the first, I append a photograph and sketch [FIG. 9] further to aid understanding and supplement the central dimple faintly shown in FIGS. 7 & 8.

Water (or any fluid) can be stirred or pumped in a continuous manner so that it adopts a dynamic, conformal shape (e.g.; eddies and swirls) somewhat akin to a raw clay bowl shaped on a potter's wheel. This geometry can be made large or small, shallow or deep, by rotating quickly or slowly depending on requirements. Thus, an effectively variable dynamic virtual base can be changed continuously in both its size (and spin), rather like an iris aperture in a camera.

The denser fluid (water in the example) as well as imparting angular momentum to the less dense fluid would also serve to prevent unwanted entry of the less dense fluid (in this example air) except as required.

Further, an outward spin and flow would discourage any unwanted ingress from the peripheral boundary. Two main versions of such a system would be either ‘unbounded’ that is within an open body of working fluid (e.g., a lake or sea) or in a specially constructed ‘bounded’ body of working fluid such as a pool or pond.

In all the general dynamic cases, a rotating medium imparts angular momentum to another less dense medium, typically as bubbles, rising within. Any inner surface rotational ‘skin effect’ of the fluid(s) could act as an impelling ‘container’ [IC].

A fourth idealised embodiment, taking the foregoing techniques, could employ various forms of illumination, either within the base of the structure itself or strategically focussed outwith on to the cloud fountain (thus incidentally improving the energetic balance by using the waste heat from whatever form of illumination was employed). Such illumination could be modulated, coloured or projected images.

A fifth idealised embodiment takes advantage of the foregoing techniques, but conceals the entire superstructure beneath the ground or submerged in water for the ‘virtual base’ case mentioned above. Such constructional means could have economic and aesthetic advantages. The only visible indication of the virtual siphon's cloud fountain (other than itself, which can of course be switched on and off at will) would be an exit hole in the ground (or water surface), such a ground station could possibly be protected by a slight mound or safety wall in the manner of a well.

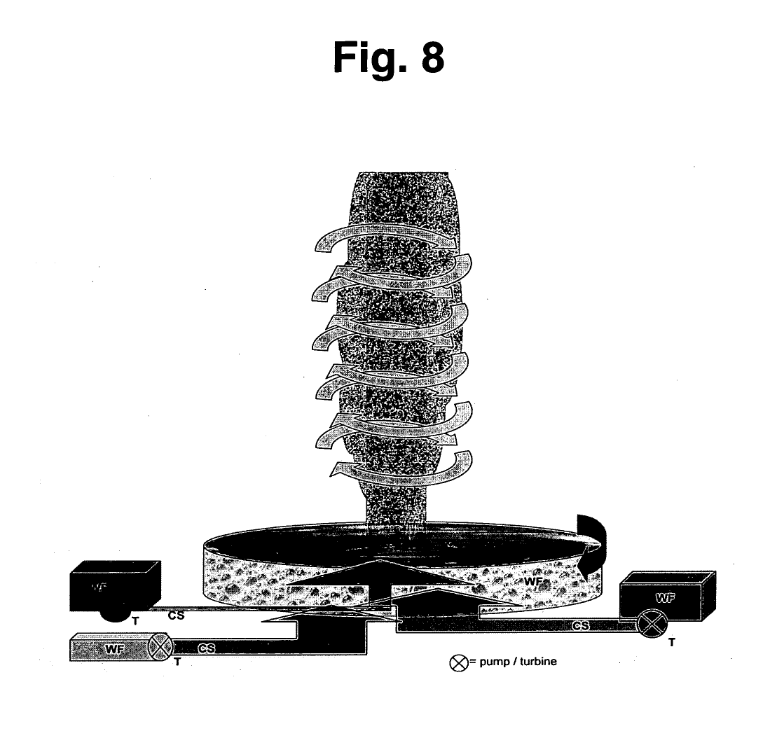

In this sixth idealised embodiment [FIG. 8], whilst adopting the foregoing means, methods and techniques, I propose harnessing any excess useful work to power generators/turbines but, as outlined above and in the foregoing embodiments, in a markedly different manner to those already suggested in the published corpus. Regardless of whether (or whatever form of) extra impulsive means are employed to start the upward-spiralling column, I can install devices within the existing conduits or extra thereto that can take advantage of the resultant pressure/density differences between the outer periphery and the inner, lower pressure axis. Specifically, whatever fluid/s or fluid mixtures are employed, there will always be an inflow, from higher to lower potential energy states, that can be channelled through conduits [CS] and converted by mechanical or electro-mechanical means to produce useful work additional to that required for maintaining the dynamic column. In the case of common working fluids [WF] such as water and air, then existing well-known turbines [T] and the like could be adapted to produce mechanical or electrical power.

In a seventh exemplary embodiment, I suggest other useful employment for the work and effects created by such virtual siphons as built by the methods outlined above. Clearly, creating such an aerial siphon could enhance or cause local precipitation of clean water for irrigation applications. Deliberately loading the column with extra water (in whatever phase or form) or with seeding particles could guarantee fresh rainfall. Purified water could also be captured at various points of ascent for human consumption purposes. Additionally, the inflow could serve to clear the immediate locality of stale air, pollution, fog or heat—also thus providing local cooling or air-conditioning within its environs. Careful positioning of the input port/s together with some of the configurations mentioned earlier above could further aid such uses.

Crucially, in all these embodiments so far mentioned and indeed in others, which should be apparent to those skilled in the art, I choose mainly to entrain the working fluids and to cause them to jet or fan out centrifugally from, or adjacent to, the inner axis and within the effective perimeter. In this way I can impart rotation to coherent convection without having to pitch any incoming convergence against outgoing centrifugal divergence, thus simplifying flow regimes and avoiding the need to construct extra barriers, friction means and the like. For example in Nature, such conflict is sometimes seen in the spray-rings at the base of waterspouts—effectively the virtual fabric of the siphon is torn at the base surface seal to allow the entrance of incoming air—the resulting turbulence indicates the energy wasted in pitching the inflow against the out-spin and the damage to the smooth siphon seal at the base. I avoid this waste of energy by the means described above.

Although these descriptions are outlines showing exemplary embodiments, there are many variations and embodiments possible utilising the general themes and approaches outlined herein and the scope of this document should be interpreted in its general principles for utilising this dynamic virtual siphon technique to overcome some of the common limitations encountered in the aforementioned fields.

1. A method for deliberately producing elongated, rotating, dynamically controllable, cyclostrophically balanced, fluid virtual siphon columns, wherein:
the term fluids encompasses any media capable of flow, including particulates;
the fluid/s can be a single medium or a mixture of materials capable of flow;
the fluid/s entrain and impart such flow in themselves and/or other fluid/s;
preferably by means of initialising and controlling near axially-fed, outwardly spinning, centrifugal, upward motion with coherent convection;
thus creating dynamically controllable, largely self-sustaining, rising updraft, rotational, cyclostrophically balanced fluid virtual siphon columns of considerable length.

2. An elongated fluid virtual siphon column producer according to claim 1, where the column's entrainment medium also acts as a virtual dynamic base and container.

3. An elongated fluid virtual siphon column producer according to claim 1, where the up-flow/updraft is harnessed directly or indirectly to produce useful work additional to that required to maintain the column itself, such work being converted to produce mechanical or electrical power.

4. A virtual siphon column producer according to claim 1, where the apparatus to produce such is largely hidden beneath the ground or water level.

5. A column producer according to claim 1, where the column is employed to carry extra water droplets or other seeding particles to enhance local precipitation, or where water vapour is condensed and captured at convenient points in the cycle.

6. A virtual siphon column producer according to claim 1, where the column's visibility is enhanced by means of condensed water, bubbles, smoke or particulate matter.

7. A fluid column producer according to claim 1, where the column's visibility is enhanced by lighting from within the base or outwith and wherein the waste heat from whatever form of lighting is employed to further improve the column's thermodynamic balance.

8. An elongated fluid virtual siphon column producer according to claim 1, where the visible column acts as a form of display screen for projected images.

9. A column producer according to claim 1, where it is employed to transport local ground fog or other pollutants or to enhance local ground level cooling breezes.

10. A column producer according to claim 1, where the column may also be employed for buoyant recreational purposes such as parascending, gliding and so on.
